(19) United States
(12) Patent Application Publication
(10) Pub. No.: US 2020/0290094 A1
(43) Pub. Date: Sep. 17, 2020

(54) POWERED SCRUBBING DEVICE WITH TELESCOPING HANDLE ACCESSORY

(71) Applicant: MOSSAB M.M.J. AL HAMLI, SAFAT (KW)

(72) Inventor: MOSSAB M.M.J. AL HAMLI, SAFAT (KW)

(21) Appl. No.: 16/351,462

(22) Filed: Mar. 12, 2019

(51) Int. Cl. B08B 1/04; A47K 7/04; A47K 7/02; A46B 13/00

(52) U.S. Cl. CPC B08B 1/04; A47K 7/043; B08B 1/002; A46B 13/008; A47K 7/028

(57) ABSTRACT

The powered scrubbing device with telescoping handle accessory includes a handheld, battery-powered scrubbing device and an attachable, telescoping handle. The battery powers a motor that drives a reciprocator, which provides linear reciprocating motion to an attached sponge or brush. The reciprocating speed may be controlled by a user through a button on a body of the device. A scrubbing pad may be removably attachable so it can be replaced when worn out or when a user requires a scrubbing pad having different scrubbing characteristics. The telescoping handle may be attached for accessing hard to reach places with the scrubbing device.

### BACKGROUND

### 1. Field

The present disclosure relates generally to powered personal hygienic appliances, and more particularly to a powered scrubbing device with telescoping handle accessory that is a small, battery-powered, waterproof, lightweight, scrubbing appliance optionally attachable to one end of a telescopic handle.

### 2. Description of the Related Art

Many people, including the elderly and disabled, have difficulty reaching much of their body for cleaning due to a lack of strength or flexibility. A wide variety of body brushes and back scrubbers are commercially available to combat this problem. These items generally consist of an extended handle attached to a cleaning head. The cleaning head is typically a mesh cloth, a sponge or a soft brush and is arranged to scrub areas of one's body by manual manipulation of the entire device. However, many people with limited flexibility, strength and/or movement, such as by virtue of a debilitating physical condition, find these cleaning products difficult to use. In addition, these products may drastically increase cleaning time, thus resulting in unnecessary fatigue. Furthermore, current powered body brushes are large and heavy making using and transporting the brush quite difficult.

Thus, a powered scrubbing device with telescoping handle accessory solving the aforementioned problems is desired.

### SUMMARY OF THE INVENTION

The powered scrubbing device with telescoping handle accessory includes a handheld, battery-powered scrubbing device and an attachable, telescoping handle. The battery powers a motor that drives a reciprocator, which provides linear reciprocating motion to an attached sponge or brush. The reciprocating speed may be controlled by a user through a button on a body of the device. A scrubbing pad may be removably attachable so it can be replaced when worn out or when a user requires a scrubbing pad having different scrubbing characteristics. The telescoping handle may be attached for accessing hard to reach places with the scrubbing device.

These and other features of the present disclosure will become readily apparent upon further review of the following specification and drawings.

### BRIEF DESCRIPTION OF THE DRAWINGS

FIG. 1 is a perspective view of a powered scrubbing device, the telescoping handle being detached.

FIG. 2 is an environmental view of the powered scrubbing device of FIG. 1 being held by a user.

FIG. 3 is a perspective view of a powered scrubbing device with telescoping handle accessory, showing attachment of the telescopic handle to the device.

FIG. 4 is a partially exploded perspective view of the powered scrubbing device of FIG. 1.

FIG. 5 is another partially exploded view of the powered scrubbing device of FIG. 1 as seen from the bottom.

FIG. 6 is an exploded view showing only a replacement scrubbing pad and a scrubbing pad mounting member of the power scrubbing device of FIG. 1.

Similar reference characters denote corresponding features consistently throughout the attached drawings.

### DETAILED DESCRIPTION OF THE PREFERRED EMBODIMENTS

The powered scrubbing device with telescoping handle accessory includes a handheld, battery-powered scrubbing device and an attachable telescoping handle. The battery powers a motor that drives a reciprocator, which provides linear reciprocating motion to an attached sponge or brush. The reciprocating speed may be controlled by a user through a button on a body of the device. A scrubbing pad may be removably attachable so it can be replaced when worn out or when a user requires a scrubbing pad having different scrubbing characteristics. The telescoping handle may be attached for accessing hard to reach places with the scrubbing device.

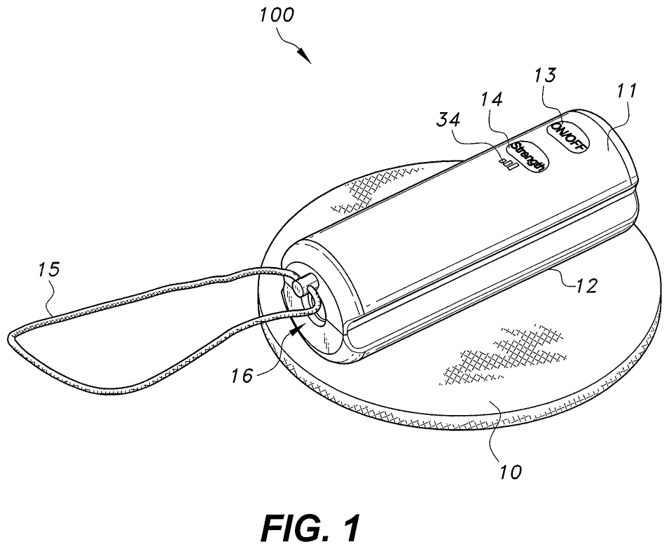

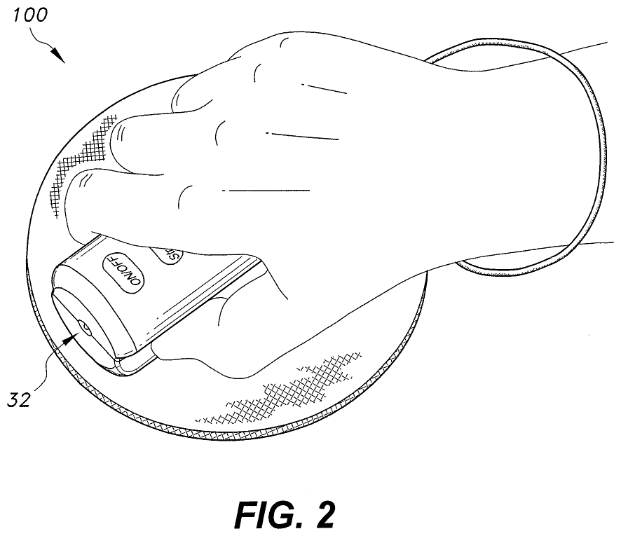

FIGS. 1 and 2 show an exemplary powered scrubbing device 100. As seen in FIG. 1, the scrubbing device 100 includes an outer shell having an upper component 11 and lower component 12, which define a generally cylindrical shape that is dimensioned and configured for being gripped and manipulated by one hand of the user. Grooves run along the length of the outer shell to accept the user's fingertips for enhancing grip. The outer shell may be made of rigid rubber, plastic, or metal. For example the shell may be made from such materials as polyvinyl chloride (PVC), polyethylene (PE), polypropylene, and/or silicone. Since the device 100 may be used by the elderly or people with disabilities, who may have trouble gripping objects, the shell may include a high friction or anti-slip coating. In addition, a safety loop 15 may be attached to a proximal end of the outer shell for looping around the user's wrist. The loop 16 will catch the scrubbing device 100 if it is accidentally dropped, thus preventing it from falling to the ground.

The top component 11 of the outer shell includes two buttons 13, 14. The first button 13 may act as an on/off toggle switch for a reciprocator housed within the outer shell, and the second button 14 may adjust the reciprocating speed. A scrubbing pad 10 is attached to scrubbing pad mounting member 21 at the output of the reciprocator. The scrubbing pad mounting member 21 extends out of a channel 30 defined in the bottom portion 12 of the shell. The largest dimension of the scrubbing pad 10 may be larger than the largest dimension of the outer shell.

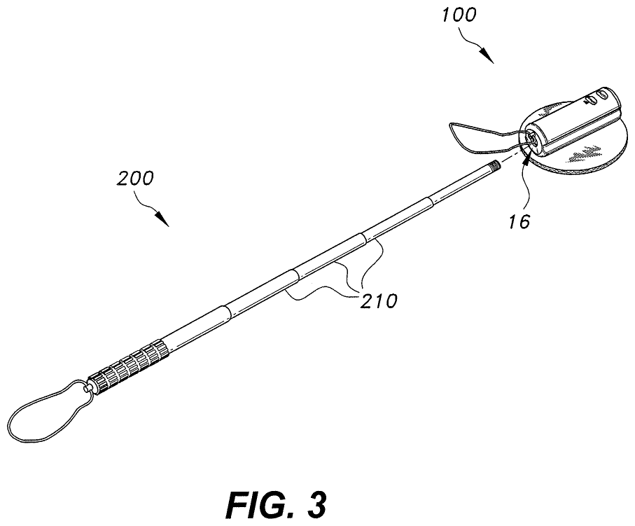

FIG. 3 shows the scrubbing device 100 with a telescoping handle accessory 200. The telescoping handle 200 may be connected to the scrubbing device through a receiving hole 16 defined in an end of the shell. As seen in FIG. 3, a longitudinal axis of the handle 200 may be aligned with the longitudinal axis of the outer shell. By aligning the axis of the handle 200 with reciprocating plane of the resilient member 10, the device 100 will be easier to control from the handle 200. The handle 200 may be attached to the receiving hole 16 using a threaded connection. Alternatively, other connections in the art may be used for attaching the handle 200 and outer shell. The telescoping portion of the handle 200 may include multiple tapered, concentric members 210 that slide in and out of each other. Other members known in the art to have an adjustable length may alternatively be used in the handle 200.

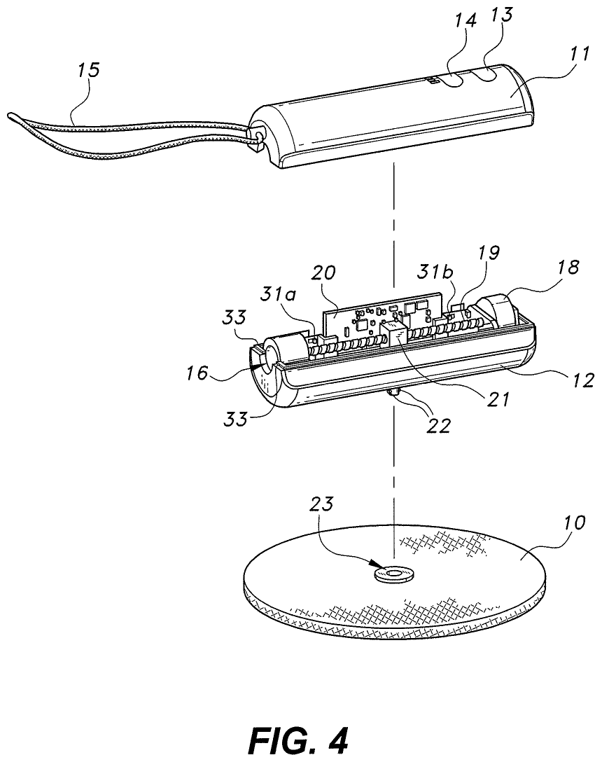

FIG. 4 shows a partially exploded view of the scrubbing device 100 with the upper component 11 of the outer shell removed from the lower component 12 to show the elements of the reciprocator. An opening in the scrubbing pad mounting member 21 is threadably engaged with a threaded shaft 19. The threaded shaft 19 is secured to the lower component 12 of the outer shell at one end in a bearing that permits axial rotation. An opposing end of the threaded shaft 19 is attached to the output shaft of a motor 18, which is also secured to the lower component 12 of the outer shell. Rotating the motor 18 causes the threaded shaft 19 to rotate in place, since it is secured at both ends. A lower portion of the scrubbing pad mounting member 21 extends through the channel 30 defined in the bottom of the lower component 12 of the outer shell. The channel 30 walls counteract rotary forces provided by the threaded member 19, resulting in the scrubbing rod mounting member 21 remaining in a vertical orientation. The threaded connection between the threaded shaft 19 and the scrubbing pad mounting member 21 causes the mounting member 21 to be translated along the length of the threaded shaft 19 when the threaded shaft 19 is rotated. Rotating the motor 18 and the attached threaded shaft 19 in a first direction causes the scrubbing pad mounting member 21 to translate along the threaded shaft 19 away from the motor 18, and rotating the motor 18 in a second, opposite direction causes the scrubbing pad mounting member 21 to translate along the threaded shaft 19 towards the motor 18. The reciprocating motion of the scrubbing pad mounting member 21 is produced by repeatedly operating the motor 18 in opposite directions for short periods of time. A center of the reciprocating range of motion may be aligned with a center of the outer shell in order to maximize the range of motion.

The motor 18 may be controlled by a controller 20 (which may be a conventional motor control circuit having power controlled by the toggle switch 13 and speed control in discrete increments controlled by toggle switch 14) that is in communication with the buttons 13, 14, the motor 18, and switches or sensors that detect the position of the scrubbing pad mounting member 21. The controller 20 may produce reciprocating motion using two limit switches 31a, 31b. One switch 31a, 31b may be located at each end of the reciprocating range of the threaded shaft 19, at a position where it may be contacted by the scrubbing pad mounting member 21. When the mounting member 21 hits the switch 31a or 31b, the switch 31a or 31b will send a signal to the controller 20, which indicates a change in motor direction, thus moving the scrubbing pad mounting member 21 away from the switch. Accordingly, the scrubbing pad mounting member 21 will operate in a reciprocating motion any time the motor 18 is operating. Other methods known in the art may be used to operate the motor in a reciprocating manner. For example, a stepper motor or a microcontroller may be used, which determines a change in motor direction based on a predetermined amount of rotations.

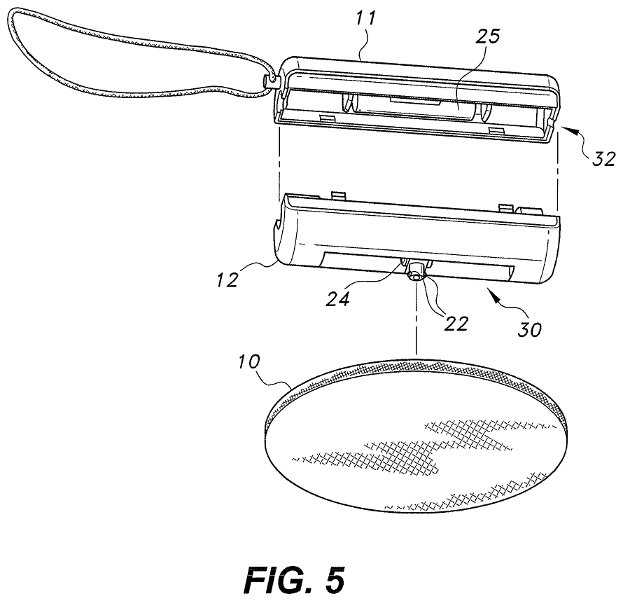

FIG. 5 shows a partially exploded view of the scrubbing device 100 with the upper 11 and lower 12 components of the outer shell separated, and the scrubbing pad 10 removed from the scrubbing pad mounting member 21. As seen in FIG. 5, the battery 25 is housed in the upper component 11 of the outer shell. The battery 25 powers all components of the reciprocator, including, but not limited to, the motor 25, the controller 20, buttons 13, 14, switches 31a, 31b, and/or sensors. The battery 25 may be rechargeable. The end of the outer shell opposite the receiving hole 16 for the handle defines an opening 32, which houses a charging port. Accordingly, to recharge the battery, a user may insert a charging adapter into the port. A battery power meter 34 may be included on the outer shell to indicate the remaining battery life to the user.

The shell provides a water-resistant or waterproof barrier to prevent the internal components from being exposed to water. Accordingly, a gasket 33 may be positioned between the upper 11 and lower 12 outer shell portions to create a watertight seal between the portions 11, 12. Additional gaskets may be used around the opening 32 for the charging port and the receiving hole 16 for the handle 200. Buttons providing a watertight seal may be used for the power button 13 and speed adjustment button 14.

A watertight mechanism may also be used to prevent water from entering through the channel 30 from which the scrubbing pad mounting member 21 extends. For example, a flexible, waterproof membrane may be sealed around the perimeter of the channel opening with an opening in the center of the membrane sealed around the scrubbing pad mounting member 21. When the scrubbing pad mounting member 21 reciprocates, the membrane will stretch to compensate for the movement and maintain the watertight seal. A loosely fitting membrane may be used so that the reciprocating motion mainly pulls the membrane taut instead of stretching it. Alternatively, flexible flaps may extend down each long side of the channel 30. The flaps may be configured so that their terminal ends are contacting in order to create a watertight seal between the flaps. The scrubbing pad mounting member 21 will extend down in-between the flaps and reciprocate back and forth at the junction between the flaps. This may be considered water-resistant. Alternatively, a center plate may be secured around the scrubbing pad mounting member 21 with a watertight seal between the mounting member 21 and the plate. Multiple stacked plates, connected to each other by tracks, can be located on either side of the mounting member 21. The plate at the top of the stack is connected to an end of the shell, and the plate at the bottom of the stack is attached to the center plate. Other mechanisms known in the art for maintaining a watertight seal around a reciprocating member may be used.

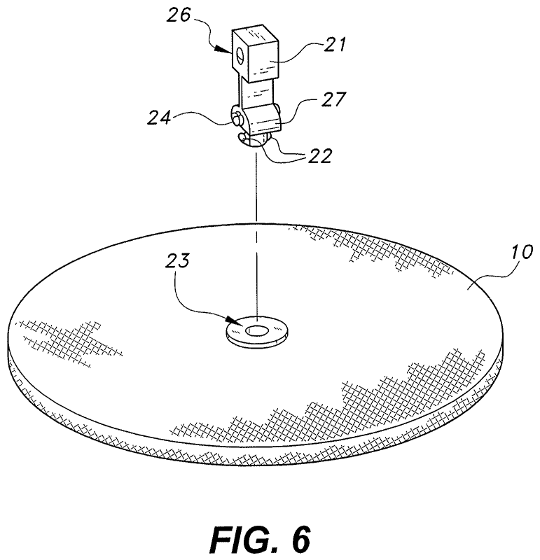

FIG. 6 shows an exploded view of the scrubbing pad 10 and the scrubbing pad mounting member 21. The upper end of the mounting member 21 includes a through-hole 26 for accepting the threaded shaft 19. The middle portion of the mounting member 21 may have a thin width so that only a small width channel 30 is necessary to allow the mounting member 21 to extend through the outer shell 12. The lower portion 12 of the outer shell will defined a recessed area (see FIG. 5) at the mouth of the channel 30 to act as a track for the lower end of the mounting member 21. Accordingly, the recess in the shell 12 may be shaped to match the outer shape of the U-shaped surface 27 at the bottom of the mounting member 21. As a result, stability of the mounting member 21 will be maintained through contact with the recess. Bearing material may be added to the mounting member 21 and/or recess to extend service life and decrease friction.

The scrubbing pad mounting member 21 shown in FIG. 6 provides an attachment mechanism for attaching the scrubbing pad 10. The mechanism includes two spring-loaded detent pins 22 on opposing sides of the mounting member 21 at its bottom. When the mounting member 21 is inserted into the receptacle 23 of the scrubbing pad 10, the pins 22 snap into detent holes formed inside the sidewall of the receptacle 23. By snapping into the holes, the detent pins 22 prevent axial and rotational movement of the scrubbing pad 10 relative to the mounting member 21, thus securing the two together. To remove the scrubbing pad 10, a user may push in on two release buttons 24 that will retract the detent pins 22 and allow the mounting member 21 to be removed from the receptacle 23 of the scrubbing pad 10. Other methods known in the art for attaching the scrubbing pad 10 to the mounting member 21 may also be used. For example, a threaded connection.

The scrubbing device 100 may be used with many different types of scrubbing pads 10. Some examples of scrubbing pad types may include sponges, brushes, scouring pads, and abrasive pads. Additionally, scrubbing pads of the same type but different textures may be used. For example, brushes with different sized bristles may be used for different cleaning procedures or portions of the body.

It is to be understood that the powered scrubbing device with telescoping handle accessory is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A powered scrubbing device with telescoping handle accessory, comprising:
a housing having an upper component and a separable lower component, the housing being dimensioned and configured for gripping by a human hand, the housing having a receptacle defined therein, wherein the lower component has a channel defined therein;
a scrubbing pad mounting member extending from the lower component, the mounting member being adapted for attaching a scrubbing pad to the housing, the scrubbing pad mounting member is elongated, having a reciprocator mounting end having a threaded bore defined therein and an opposing scrubbing pad attachment end, wherein the scrubbing pad mounting member extends through the lower component channel, the channel constraining the scrubbing pad mounting member to linear reciprocation in the channel;
a battery-powered reciprocating assembly mounted within the housing, the mounting member being attached to the reciprocating assembly for selectively reciprocating a scrubbing pad attached to the mounting member for only linear reciprocation in the channel, the battery-powered reciprocating assembly consisting of:
i) a motor having a shaft;
ii) a threaded shaft having a first end coupled to the shaft of the motor and a second end, the threaded shaft extending through and engaging the threaded bore defined in the scrubbing pad mounting member;
iii) a bearing disposed in the lower component of said housing, the second end of the threaded shaft being journaled in the bearing for rotation in the bearing;
iv) a motor controller circuit connected to the motor, the controller circuit including:
a) a power circuit having an on/off button extending through the housing;
b) a speed control circuit having a control button extending through the housing, and a circuit for controlling direction of rotation of the shaft of the motor;
c) a first limit switch and a second limit switch connected to the motor controller circuit, the limit switches being spaced apart along said threaded shaft, the motor controller circuit reversing the direction of rotation of the shaft of the motor when thescrubbing pad mounting member reached the limit switches to reciprocate motion of the scrubbing pad mounting member in the channel; and
v) a battery power supply connected to the power circuit of the motor control circuit;
wherein rotation of the shaft of the motor results in translation of the scrubbing pad mounting member along the threaded shaft in reciprocating motion when the direction of rotation of the shaft of the motor is reversed; and
a handle removably attached to the housing receptacle, the handle having telescoping members selectively extending and contracting the handle to provide adjustable length for extending and retracting the reciprocating scrubbing pad, whereby a user may optionally use the device by gripping the housing or by attaching the telescoping handle for extended reach.

2. The powered scrubbing device of claim 1, wherein said housing is waterproof

3. The powered scrubbing device of claim 1, wherein said housing is water-resistant.

4-6. (canceled)

7. The powered scrubbing device of claim 1, further comprising the scrubbing pad.

8. The powered scrubbing device of claim 7, wherein said scrubbing pad is selected from the group consisting of a brush, a sponge, a scouring pad, and an abrasive pad.

9. The powered scrubbing device of claim 7, wherein said scrubbing pad has opposing sides and a central hub mounted in at least one of the sides, the hub having diametrically opposed detent holes defined therein.

10. The powered scrubbing device of claim 9, wherein the pad attachment end of said scrubbing pad mounting member has diametrically opposed spring-biased detent pins mounted thereon, the detent pins selectively engaging the detent holes defined in the hub of the scouring scrubbing pad to selectively retain the scouring pad on said scrubbing pad mounting member.

11. The powered scrubbing device of claim 10, wherein the pad attachment end of said scrubbing pad mounting member further comprises diametrically opposed release buttons mounted thereon, the release buttons releasing spring bias from said detent buttons when the release buttons are depressed in order to release the scouring pad from said scrubbing pad mounting member.
